(19) United States
(12) Patent Application Publication
(10) Pub. No.: US 2022/0198230 A1
(43) Pub. Date: Jun. 23, 2022

(54) AUXILIARY DETECTION METHOD AND IMAGE RECOGNITION METHOD FOR RIB FRACTURES BASED ON DEEP LEARNING

(71) Applicant: Shenzhen Imsight Medical Technology Co., Ltd., Shenzhen (CN)

(72) Inventors: Hao Chen, Shenzhen (CN); Yu Hu, Shenzhen (CN); Zhizhong Chai, Shenzhen (CN); Guangwu Qian, Shenzhen (CN)

(21) Appl. No.: 17/189,194

(22) Filed: Mar. 1, 2021

(30) Foreign Application Priority Data
Dec. 17, 2020 (CN) 202011497567.6

(51) Int. Cl. G06K 9/62

(52) U.S. Cl. CPC G06K 9/6298; G06K 9/6256; G06K 2209/051; G06K 9/627; G06K 9/6277

(57) ABSTRACT

The present invention relates to the technical field of medical treatment, in particular to an auxiliary detection method and image recognition method for rib fractures based on a deep learning algorithm. The auxiliary detection method comprises the following steps: selecting a certain number of chest CT images as a training set, and labeling a rib fracture area and a rib number in the chest CT images; performing data normalization on the image; training a model by taking the processed image as an input, and the rib fracture area and rib number in the labeled image as an output, wherein the training model comprises a rib detection model, a rib fracture segmentation model, and a rib numbering and sectioning model; and processing the chest CT image to be detected and inputting the processed chest CT image into a trained rib fracture detection model, and outputting a detection result. According to the auxiliary detection method for rib fractures based on the deep learning algorithm provided by the embodiment of the present invention, the cases of false positive and false negative of rib fracture detection are effectively reduced. In addition, this detection result provides position information of a suspected rib fracture, which can assist doctors in diagnosis.

### TECHNICAL FIELD

The present invention relates to the technical field of medical treatment, in particular to an auxiliary detection method and image recognition method for rib fractures based on deep learning.

### BACKGROUND ART

Computed tomography (CT) is a main method used to diagnose rib fractures in the chest. CT chest examination for rib fractures is a time-consuming and labor-intensive process. Because of unique anatomical shapes of the ribs, each rib needs to be repeatedly observed on a plurality of CT cross-sectional planes from the upper rear part to the lower front part, and the evaluation on each of the ribs on left and right sides is completed in sequence, which is time-consuming and labor-intensive, thereby bringing difficulties to the diagnosis.

The existing intelligent auxiliary detection system for rib fractures can obtain suspected lesion areas in combination with traditional detection models, to assist doctors in diagnosis. With the development of deep learning, many computer vision tasks have developed rapidly due to the rise of deep learning. Data-driven deep learning models have achieved better results than traditional detection models. More and more deep convolutional neural network algorithm techniques are applied to the medicine. The data-driven deep learning model is used to collect original CT images first in an auxiliary detection manner; then obtain corresponding expansion maps based on the ribs in the images; then obtain a lesion area of the suspected rib fracture by taking the expansion map of each rib as an output of an automatic detection model; and then label the lesion area in the system to remind the doctor that there is a suspected lesion area.

However, in this method, only the suspected lesion area can be labeled, without positioning analysis of the suspected lesion, e.g., without labeling a section where a fracture occurs on a rib at the left/right side, such that a reporting doctor needs to make further judgments based on the images when writing a report, which is also a time-consuming and labor-intensive process. In addition, the traditional detection algorithms have high false negatives and false positives.

### SUMMARY OF THE INVENTION

With respect to the above technical solutions, embodiments of the present invention provide an auxiliary detection method and image recognition method for rib fractures based on a deep learning algorithm, to solve one or more problems that, when a traditional deep learning model is used for auxiliary detection for CT of rib fractures, a lesion area cannot be located and analyzed, and the detection is not accurate.

In a first aspect, an embodiment of the present invention provides an auxiliary detection method for rib fractures based on a deep learning algorithm, which comprises the following steps: selecting a certain number of chest CT images as a training set, and labeling a rib fracture area and a rib number in each chest CT image; performing data normalization on the chest CT image; training a rib fracture detection model by taking the normalized chest CT image as an input, and the rib fracture area and rib number in the labeled chest CT image as an output, wherein the rib fracture detection model comprises a rib detection model, a rib fracture segmentation model, and a rib numbering and sectioning model; and processing the chest CT image to be detected and inputting the processed chest CT image into the trained rib fracture detection model, and outputting a detection result.

In a second aspect, an embodiment of the present invention provides an image recognition method based on a deep learning algorithm, which comprises the following steps: selecting a certain number of chest CT images as a training set, and labeling a rib fracture area and a rib number in each of the chest CT images; performing data normalization on the chest CT image; training a deep learning model by taking the normalized chest CT image as an input, and the rib fracture area and rib number in the labeled chest CT image as an output, wherein the deep learning model comprises a detection model, a segmentation model, and a numbering and sectioning model; and processing the chest CT image to be detected and inputting the processed chest CT image into the trained deep learning model, and outputting an image recognition result.

Optionally, the detection model is a Faster-RCNN deep neural network model, and the output of the Faster-RCNN deep neural network model is a segmented template of a rib.

Optionally, the segmentation model is a UNet segmentation neural network model, and the output of the UNet segmentation neural network model is the labeled rib fracture area.

Optionally, the output of the numbering and sectioning model is position information of the rib fracture area.

Optionally, the position information of the rib fracture area includes one or more of the followings: left ribs, right ribs, N^{th} ribs, underarm ribs, anterior ribs, and posterior ribs, N being a positive integer.

Optionally, the output of the deep learning model includes a probability that the chest CT image to be detected has a rib fracture.

Optionally, the method further comprises: setting a confidence level threshold, and determining that an image recognition result of the chest CT image to be detected is a rib fracture if the probability that the chest CT image to be detected has a rib fracture is greater than the confidence level threshold.

Optionally, the step of performing data normalization on the chest CT images specifically comprises: reading pixel parameters of each chest CT image, wherein the pixel parameters represent an actual distance between each pixel and its corresponding chest CT; and zooming in or out the chest CT image according to the pixel parameters, to achieve the normalization in a physical size.

Optionally, the method further comprises: performing a flipping and/or mirroring operation on the chest CT image to expand the training set.

According to the auxiliary detection method and image recognition method for rib fractures based on the deep learning algorithm provided by the embodiments of the present invention, the cases of false positive and false negative of rib fracture detection are reduced effectively. In addition, this detection result provides position information of suspected rib fracture, which can assist doctors in diagnosis.

### BRIEF DESCRIPTION OF THE DRAWINGS

One or more embodiments are exemplified by the pictures in the corresponding attached drawings, and these exemplified descriptions do not constitute a limitation on the embodiments. Elements with the same reference numerals in the attached drawings represent similar elements. Unless otherwise stated, the pictures in the attached drawings do not constitute a scale limitation.

FIG. 1 is a schematic flowchart of an auxiliary detection method for rib fractures based on a deep learning algorithm according to an embodiment of the present invention;

FIG. 2 is a schematic diagram in which a rib fracture area is labeled based on data in a training set before training provided by an embodiment of the present invention;

FIG. 3 is a schematic diagram in which ribs in each image are labeled in a pixel level before training provided by an embodiment of the present invention;

FIG. 4 is a schematic diagram of a chest CT image input by a deep learning model provided by an embodiment of the present invention; and

FIG. 5 is a schematic diagram of a recognition result outputted by a deep learning model provided by an embodiment of the present invention.

### DETAILED DESCRIPTION

In order to facilitate the understanding of the present invention, the present invention will be described in more detail below with reference to the accompanying drawings and specific embodiments. It should be also noted that when a component is referred to as “being fixed to” the other component, the component can be directly disposed on the other component, or there may be one or more intermediate components therebetween. When a component is referred to as “being connected with” the other component, the component can be directly connected to the other component, or there may be one or more intermediate components therebetween. Orientation or positional relationships indicated by the terms “upper”, “lower”, “inner”, “outer”, “bottom”, etc. are orientation or positional relationships shown on the basis of the accompanying drawings, only for the purposes of the ease in describing the present disclosure and simplification of its descriptions, but not indicating or implying that the specified device or element has to be specifically located, and structured and operated in a specific direction, and therefore, should not be understood as limitations to the present invention. Moreover, the terms “first”, “second”, “third” and the like are only for the purpose of description and should not be construed as indicating or implying relative importance.

Unless defined otherwise, all technical and scientific terms used herein have the same meaning as commonly understood by those skilled in the art to which the present invention belongs. The terms used herein in the description of the present invention are for the purpose of describing particular embodiments only and are not intended to limit the present invention. The term “and/or” as used herein includes any and all combinations of one or more of the associated listed items.

According to the methods disclosed by the present invention, based on a customized deep convolutional neural network model, the suspected rib fracture area in the chest CT image and the position information of the rib fracture can be displayed for a doctor, so as to provide structured image findings and diagnostic opinions for doctors to make references. The present invention will be described in detail below.

Firstly, an embodiment of the present invention provides an auxiliary detection method for rib fractures based on a deep learning algorithm, which comprises the following steps: selecting a certain number of chest CT images as a training set, and labeling a rib fracture area and a rib number in each chest CT image; performing data normalization on the chest CT image; training a rib fracture detection model by taking the normalized chest CT image as an input, and the rib fracture area and rib number in the labeled chest CT image as an output, wherein the rib fracture detection model comprises a rib detection model, a rib fracture segmentation model, and a rib numbering and sectioning model; and processing the chest CT image to be detected and inputting the processed chest CT image into the trained rib fracture detection model, and outputting a detection result. According to this method, the cases of false positive and false negative of rib fracture detection are reduced effectively. In addition, this detection result provides position information of suspected rib fracture, which can assist doctors in diagnosis.

The specific implementation of the auxiliary detection method for rib fractures based on the deep learning algorithm provided in this embodiment is similar to the specific implementation of the following image recognition method. The following embodiments of the image recognition method based on the deep learning algorithm are also applicable to the auxiliary detection method for rib fractures based on the deep learning algorithm. The auxiliary detection method for rib fractures based on the deep learning algorithm will be described below in detail.

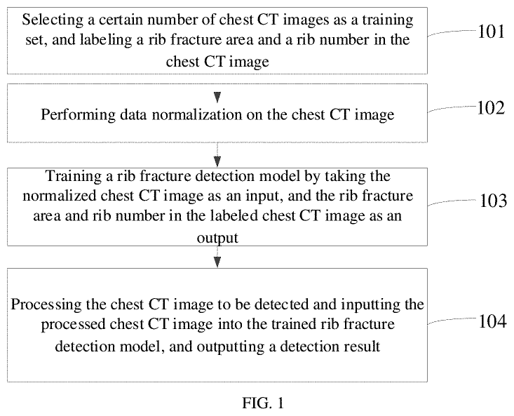

Referring to FIG. 1, an embodiment of the present invention further provides an image recognition method based on a deep learning algorithm. As shown in FIG. 1, this method comprises the following steps.

In step 101, selecting a certain number of chest CT images as a training set, and labeling a rib fracture area and a rib number in the chest CT image.

In the present invention, a convolutional neural network is constructed based on deep learning for chest CT image recognition. Deep learning refers to a technology that performs feature extraction and model parameter adjustment on a large number of samples based on the samples through a backpropagation algorithm. According to the method of the present invention, in a data preparation phase, a chest CT image containing 11527 cases is first constructed, including 3261 cases containing positive data for rib fractures (each case contains at least one fracture), and 8266 cases containing negative data for rib fractures (a diagnostic report shows no rib fracture found in the images).

With respect to the data set containing 11527 cases, during the operation, 2425 cases containing positive data are randomly selected for model training to form a training data set of chest CT images. The remaining 9102 cases of data are used as a test data set in the present invention. The chest CT images as the training set are acquired from hospital's PACS (Picture Archiving and Communication Systems) or a DR or CR device through a DICOM protocol.

The manner of labeling the data in the training set before training is as follows:

with respect to the positive data in the training set containing 2425 cases, a slice-wise rectangular labeling method is adopted. Specifically, Doctor 1 firstly labels the chest CT images layer by layer, and completely records a vertex coordinate position of each rectangle, wherein an outline of the rectangular label covers the rib fracture area as completely as possible in the labeling process.

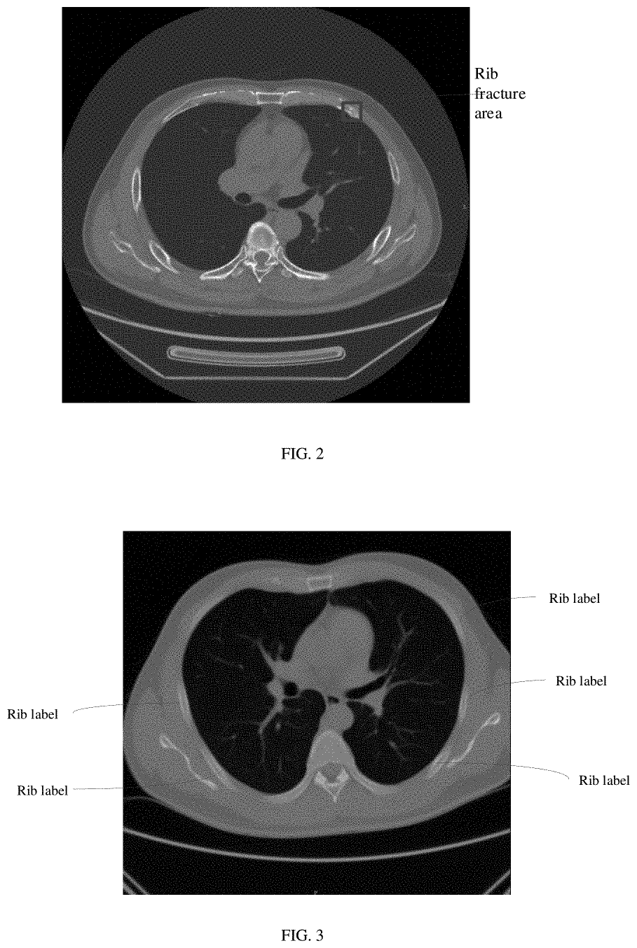

After Doctor 1 has completed the labeling, Doctor 2 will review the labels of Doctor 1. If Doctor 1 has omissions or mistakes, Doctor 2 will correct the labels. Finally, the corrected labels of Doctor 2 are shown in FIG. 2 as gold standards.

Because the position information of the rib fracture area needs to be confirmed in the end, the ribs also need to be numbered, that is, numbering training is performed. According to the present invention, with respect to the training set used for rib numbering, Doctor 3 adopts a slice-wise labeling method to label the ribs in each image in a pixel level. In the case of labeling, an outline of a mask should cover the corresponding rib area as much as possible, and the pixel coordinates of the ribs are completely recorded. The labeling results are shown in FIG. 3.

In step 102, performing data normalization on the chest CT image.

Since the chest CT images come from different centers, the chest CT images as the training set may cause that actual physical sizes of the images represented by single pixels are different due to different software parameter settings and post-processing algorithms. The purpose of data normalization here is to ensure that the images in the training set have similar physical sizes as much as possible. According to the present invention, a spacing between every two of all chest CT images in a z-direction is uniformly normalized to 3 mm, thereby reducing the influence of differentiation on the models. In the deployment and application scenarios of the following models, the inputted data should also be normalized in the same way.

In order to use the limited training data to make the generalization ability of the model stronger, the chest CT images in the training set can be subjected to a flipping and/or minoring operation, thereby achieving the expansion of the training set data. In the present invention, the data expansion of the training set includes the following steps:

vertical minoring: randomly mirroring the training data set and its labeled images vertically;

horizontal mirroring: randomly mirroring the training data set and its labeled images horizontally; and

flipping: randomly flipping the training data set and its labeled images clockwise at a flip angle of 0 degrees, 90 degrees, 180 degrees or 270 degrees.

The training set expanded by the above method refers to the training data used by three training neural networks. It should be noted that the above-mentioned mirroring followed by flipping is only one of the implementations of the present invention to expand the training set. In other embodiments, the training set may be expanded by flipping followed by mirroring, or minoring only, or flipping only, or the like.

In step 103, training a rib fracture detection model by taking the normalized chest CT image as an input, and the rib fracture area and rib number in the labeled chest CT image as an output.

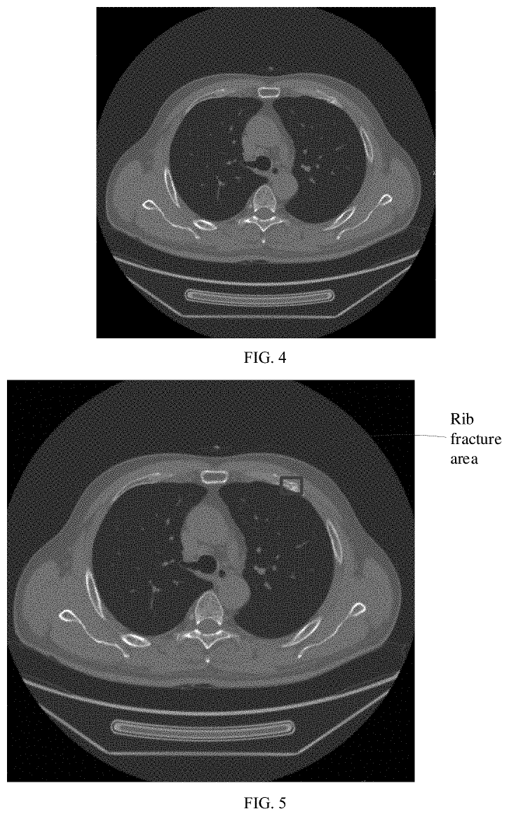

In the present invention, the input of the deep learning model is a chest CT slice image of 1024*1024*3 as shown in FIG. 4, and the output of the deep learning model is a rectangular frame list of each slice image shown in FIG. 5 (which is the same as the doctor's label of the rib fracture area in FIG. 2). Each list contains a plurality of rectangular boxes (the rectangular boxes cover the rib area). Each rectangular box has three attribute values: center coordinates, length and width, and probability. That is, the output of the deep learning model includes a probability that the chest CT image to be detected has a rib fracture. In the present invention, an area with the highest predicted probability which is higher than a threshold of 0.5 is regarded as the final output of the model.

In this embodiment of the present invention, the deep learning model includes: a detection model, a segmentation model, and a sectioning model. The three models are described separately below.

The detection model is a Faster-RCNN model. The Faster-RCNN model is an image segmentation model based on a convolutional neural network. The model is trained by using a large amount of labeled data to obtain a good classification effect.

In this embodiment of the present invention, the Faster-RCNN model totally includes the following four structures: a feature extraction network, an area selection network, a classification network and a 2D segmentation network.

1. Feature Extraction Network.

The feature extraction network is a neural network architecture composed of repeatedly stacked convolutional layers, sampling layers and nonlinear activation layers. The neural network architecture is pre-trained with a large amount of image data and category labels of objects contained in the images on the basis of a back-propagation algorithm in deep learning, to summarize and extract abstract features of the images, and output high-dimensional feature tensors of the images. In the present invention, the feature extraction network refers to a feature extraction network of a modified Resnet-50 classification network. The input of the feature extraction network is a chest CT slice image of 1024*1024*3, and the output thereof is a high-dimensional tensor of 32*32*2048.

2. Area Selection Network.

The area selection network is composed of a fully-connected layer and a nonlinear activation layer. The area selection network performs sliding window classification and object bounding box coordinate regression on the high-dimensional tensors output by the feature extraction network. The classification result is to judge a probability that the current window position has a rib fracture and estimate sizes and aspect ratios of cells contained in the current window. The current window position corresponds to a corresponding coordinate position in the original chest CT slice image. The position and size of the rib fracture, and an aspect ratio of a circumscribed rectangular frame can be estimated through the area selection network.

In the present invention, a feature pyramid network FPN can be adopted as the area selection network. The pyramid network FPN can fuse multi-scale feature information, and thus significantly improve the detection of small targets.

The input of the FPN network is a high-dimensional tensor of 32*32*2048, a middle layer is a 256-dimensional feature vector, and a classification output layer is a fully-connected layer. The 256-dimensional vector achieves fully-connected output of categories of targets included in the current area, each category having a 2-bit sparse vector representation (rib fracture+background). The rectangular box position regression is the same as in the fully-connected layer, i.e., the 256-dimensional vector achieves fully-connected output of floating point values of the abscissa, ordinate, length and width of the targets in the current area, which are normalized between [0,1] relative to coordinates of the upper left corner of the circumscribed rectangular frame in a sub-tensor coordinate center. Through the area selection network, a feature sub-tensor of the rib fracture is acquired, wherein the feature sub-tensor corresponds to a rib fracture position in the high-dimensional feature tensors output by the feature extraction network.

3. Classification Network.

The classification network is composed of stacked fully-connected layers and nonlinear activation layers. The classification network is used to classify the high-dimensional feature tensors corresponding to the positions of the rib fractures in the output of the area selection network, and determine whether the target contained in this area is a rib fracture or a background.

4. 2D Segmentation Network.

The 2D segmentation network is composed of repeatedly stacked convolutional layers. The segmentation network involves convolution and transposed convolution. The input of the segmentation network is a sub-tensor of the high-dimensional tensor in the output result of the feature extraction network corresponding to an area that contains cells and nuclei in the classification result in the area selection network. This sub-tensor contains abstract codes for shapes and features of cells and nuclei in the original image. The 2D segmentation network decodes and reconstructs the abstract codes of the image in this sub-tensor, and outputs the reconstructed segmented template, thereby completing the pixel-level classification of ribs in the chest CT image.

In the present invention, the 2D segmentation network first performs bilinear difference on the high-dimensional tensors in FPN to obtain a feature tensor with a fixed size of 512*512*4, which is used as the input of the segmentation network. The 2D segmentation network consists of a conventional convolutional layer having a convolution kernel of 3*3*256, a transposed convolutional layer (connected to a nonlinear activation layer) having a convolution kernel of 2*2*256 and a step size of 2, and a convolution output layer having a convolution kernel of 1*1*1. The output result is a segmented template corresponding to a rib. After the segmented template is obtained, the template is enlarged to the size of the original CT image area by bilinear difference, so as to obtain the segmentation output of the rib. That is, the output of the Faster-RCNN deep neural network model is a segmented template of the rib.

In the present invention, the segmentation model is a UNet segmentation neural network model, and the output of the UNet segmentation neural network model is the labeled rib fracture area.

The input of the UNet segmentation neural network is three-dimensional patch having a size of 256*256*48. The network structure is mainly composed of an encoder and a decoder. The encoder is composed of a series of repeatedly stacked convolutional layers and pooling layers, and the decoder is composed of a series of convolutional layers and transposed convolutional layers. In the entire network process, high-level features and low-level features are fused layer by layer, semantic information and spatial information complement each other, and finally the three-dimensional segmented template, i.e., the rib fracture area, of the rib is output.

The sectioning model of the present invention consists of a numbering and sectioning algorithm. Its specific implementation is as follows: a connected domain set is selected from a rib mask and labeled as L; then, L is divided into two sets of L1 and L2 (left and right) by using a centerline cutting method; finally, the connected domains in each set are ranked according to sizes of their mass centers in a z direction, to obtain a mask of a rib number. With respect to the connected domain set and L, left and right endpoints of each connected domain are found. Each connected domain (that is, each rib) is then divided into an anterior segment, an axillary segment and a posterior segment according to the nearest neighbor algorithm, to obtain the position information of the rib fracture area.

According to this embodiment of the present invention, model parameters are obtained by training by means of a backpropagation algorithm in deep learning. The classification network and the area selection network use a target real category vector and the coordinates of an input area relative to the input tensor coordinate center as labels, and a loss function as a cross entropy function.

In this embodiment of the present invention, the parameters of the feature extraction network are initialized by removing parameters of the fully-connected layer from a network pre-trained in an ImageNet classification network. Other relevant network parameters are randomly and initially selected from parameters in [0,1] that obey the truncated normal distribution. A stochastic gradient descent backpropagation algorithm is used to train for 360 cycles in the enhanced training set at a learning law of 0.001.

After the above training is completed, segmentation results are counted on a verification set (the remaining 9102 cases of data are used as a test data set for verification) through the obtained model. That is, all the segmentation results of the images in each verification set are superimposed together to form the segmented template of the images. Next, a Euclidean distance between the segmented template and the actual label is calculated. The Euclidean distance is an inference error of a single image. Finally, the inference errors of all pictures in the verification set are added together to obtain a verification set error. In this embodiment of the present invention, during the training process, the model with the lowest error in the verification set is selected as the final training model.

In this embodiment of the present invention, the output of the deep learning model is a probability that the target area has a rib fracture. In the present invention, an area with the highest predicted probability which is higher than a threshold of 0.5 is regarded as the final output of the model. All targets output by the model are processed with a non-maximum suppression (NMS) algorithm to eliminate highly overlapped detection results.

In this embodiment of the present invention, the output of the segmentation model is the labeled rib fracture area. Then, the rib number and the segmented template of the rib segment can be obtained through a post-processing algorithm of the sectioning model. Finally, a detection frame is combined with a numbering template and a sectioning template to obtain the fine positioning of the rib fracture.

In step 104, processing the chest CT image to be detected and inputting the processed chest CT image into the trained rib fracture detection model, and outputting a detection result.

The deep learning model includes a detection model, a segmentation model, and a sectioning model. In applications, the chest CT image to be detected is input into the trained detection model, the segmentation model and the sectioning model, and a recognition result is output. The recognition result is the rib fracture area and the position information of the rib fracture. The positions where the rib fractures happen refer to left ribs, right ribs, N^{th} ribs, underarm ribs, anterior ribs, and posterior ribs, N being a positive integer.

It should be noted that the model training method in this embodiment of the present invention is as the result of the creative work of those skilled in the art. Any changes, adjustments or replacement schemes for a data enhancement method, a neural network architecture, a hyperparameter and a loss function of the present invention on the basis of the embodiments of the present invention should be regarded as being equivalent to this scheme.

According to the auxiliary detection method for CT of rib fractures based on the deep learning algorithm provided by the embodiment of the present invention, information about whether the target image has a rib fracture, the fracture area and the position of the fracture may be obtained by inputting any chest CT image into the model obtained in step 103. According to the auxiliary detection method for CT of rib fractures based on the deep learning algorithm provided by the embodiment of the present invention, the cases of the false positive and false negative of rib fracture detection are effectively reduced. In addition, this detection result provides position information of a suspected rib fracture, which can assist doctors in diagnosis. On this basis, when the results are outputted, it is also possible to provide materials for the doctor to write a diagnosis report by providing the texts of the formatted image findings and the diagnosis opinions.

Those skilled in the art should further appreciate that various steps of the exemplary bifocal image integration method described in the embodiment disclosed herein can be implemented in the form of electronic hardware, computer software, or a combination of both. For clarity of the interchangeability of the hardware and software, the composition and steps of the various examples have been generally described in terms of function in the above description. Whether these functions are executed in the form of the hardware or software depends on the specific application and design constraints of the technical solution.

Those skilled in the art may implement the described functions with different methods for each of particular applications, but such implementation shall not be regarded as going beyond the scope of the present invention. The computer software may be stored in a computer-readable storage medium, and when executed, may include the processes of the above-mentioned method embodiment. The storage medium may be a magnetic disk, an optical disk, a read-only memory, a random memory or the like.

At last, it should be noted: the above embodiments are merely used to illustrate the technical solutions of the present invention, but are not limited thereto. Under the idea of the present invention, the technical features in the above embodiments or different embodiments can also be combined. The steps can be implemented in any order, and there are many other variations of the different aspects of the present invention as described above. For clarity, they are not provided in the details. Although the present invention is described in detail with reference to the above embodiments, a person of ordinary skill in the art should understand: the technical solutions described in the foregoing embodiments may be modified, or some or all of the technical features may be equivalently replaced. However, these modifications and substitutions do not make the corresponding technical solutions depart from the scope of the technical solutions in the embodiments of the present invention.

What is claimed is:

1. An auxiliary detection method for rib fractures based on a deep learning algorithm, comprising the following steps:
selecting a certain number of chest CT images as a training set, and labeling a rib fracture area and a rib number in the chest CT image;
performing data normalization on the chest CT image;
training a rib fracture detection model by taking the normalized chest CT image as an input, and the rib fracture area and rib number in the labeled chest CT image as an output, wherein the rib fracture detection model comprises a rib detection model, a rib fracture segmentation model, and a rib numbering and sectioning model; and
processing the chest CT image to be detected and inputting the processed chest CT image into the trained rib fracture detection model, and outputting a detection result.

2. An image recognition method based on a deep learning algorithm, comprising the following steps:
selecting a certain number of chest CT images as a training set, and labeling a rib fracture area and a rib number in each chest CT image;
performing data normalization on the chest CT image;
training a deep learning model by taking the normalized chest CT image as an input, and the rib fracture area and rib number in each labeled chest CT image as an output, wherein the training model comprises a detection model, a segmentation model, and a sectioning model; and
processing the chest CT image to be detected and inputting the processed chest CT image into the trained deep learning model, and outputting an image recognition result.

3. The method according to claim 2, wherein the detection model is a Faster-RCNN deep neural network model, and the output of the Faster-RCNN deep neural network model is a segmented template of a rib.

4. The method according to claim 2, wherein the segmentation model is a UNet segmentation neural network model, and the output of the UNet segmentation neural network model is the labeled rib fracture area.

5. The method according to claim 2, wherein the output of the number and the sectioning model is position information of the rib fracture area.

6. The method according to claim 5, wherein the position information of the rib fracture area includes one or more of the followings:
left ribs, right ribs, N^{th} ribs, underarm ribs, anterior ribs, and posterior ribs, N being a positive integer.

7. The method according to claim 2, wherein the output of the deep learning model includes a probability that the chest CT image to be detected has a rib fracture.

8. The method according to claim 5, further comprising: setting a confidence level threshold, and determining that an image recognition result of the chest CT image to be detected is a rib fracture if the probability that the chest CT image to be detected has a rib fracture is greater than the confidence level threshold.

9. The method according to claim 2, wherein the step of performing data normalization on the chest CT images specifically comprises:
reading pixel parameters of each chest CT image, wherein the pixel parameters represent an actual distance between each pixel and its corresponding chest CT; and
zooming in or out the chest CT image according to the pixel parameters, to achieve the normalization in a physical size.

10. The method according to claim 8, further comprising: performing a flipping and/or mirroring operation on the chest CT image to expand the training set.
